(19) United States
(12) Patent Application Publication
(10) Pub. No.: US 2026/0155363 A1
(43) Pub. Date: Jun. 4, 2026

(54) Thermally Regenerative Electrochemical Cell

(71) Applicants: IUCF-HYU (Industry-University Cooperation Foundation Hanyang University), Seoul (KR); Korea University Research and Business Foundation, Seoul (KR)

(72) Inventors: Kihoon Ryu, Seoul (KR); Eunho Choi, Seoul (KR); Yundong Lee, Seoul (KR); Wonjoon Choi, Seoul (KR); Sangtae Kim, Seoul (KR)

(21) Appl. No.: 18/963,773

(22) Filed: Nov. 29, 2024

(51) Int. Cl. H01M 4/40; H01M 4/02; H01M 4/66; H01M 4/80; H01M 10/0568; H01M 10/0569; H01M 10/38; H01M 50/109

(52) U.S. Cl. CPC H01M 4/40; H01M 4/661; H01M 4/663; H01M 4/808; H01M 10/0568; H01M 10/0569; H01M 10/38; H01M 50/109; H01M 2004/021; H01M 2300/0037

(57) ABSTRACT

A thermally regenerative electrochemical cell is disclosed. In an embodiment, provided is a thermally regenerative electrochemical cell which includes a first electrode including Na or K; a second electrode including an alloy represented by Chemical Formula 1; and an electrolyte between the first electrode and the second electrode; wherein power output is generated by an electrochemical reaction as the temperatures of the first electrode and the second electrode change simultaneously:

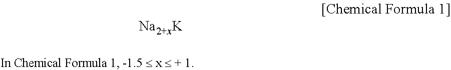

### FIELD OF THE INVENTION

A thermally regenerative electrochemical cell is disclosed.

### DESCRIPTION OF THE RELATED ART

A thermogalvanic cell (TG cell) is known as one of elements that apply an electrochemical reaction depending on a temperature.

However, the thermogalvanic cell has a problem of being not commercially available due to low efficiency (ZT), which is caused by two main reasons.

First, in the thermogalvanic cell field, thermopower (a) of electrode materials known to date is low.

In order to increase efficiency of the thermogalvanic cell, it is necessary to apply an electrode material that exhibits high thermopower (a). Up to now, electrode materials such as TE (Bi₂Te₃, α=0.2 mV/K), TG-Solid (LiCoO₂, α=1.2 mV/K), TG-Liquid (Fe(CN)₆^{3-/4-}, α=4.2 mV/K), and the like have been researched but failed in significantly increasing the efficiency of the thermogalvanic cell.

In addition, the thermogalvanic cell is operated under difficult conditions.

As shown in FIG. 1, the thermogalvanic cell is composed of a low-temperature electrode, a high-temperature electrode, and an electrolyte, and is a cell that produces electricity through an electrochemical reaction that occurs when a temperature difference exists between the two electrodes. Herein, the temperature difference between the two electrodes is not technically easy to form and maintain.

### SUMMARY OF THE INVENTION

### a. Problem to be Solved

An embodiment provides a novel structure for a cell that applies an electrochemical reaction depending on a temperature.

Specifically, provided is a novel thermal regenerative electrochemical cell that applies a Na₂₊ₓK-based alloy as a material exhibiting significantly higher thermopower (a) than the electrode materials known up to date and also, has a structure of being operated under easier conditions than those of the thermogalvanic cell.

### b. Solution

A thermally regenerative electrochemical cell is disclosed. In an embodiment, provided is a thermally regenerative electrochemical cell which includes a first electrode including Na, K, or a combination thereof; a second electrode including an alloy represented by Chemical Formula 1; and an electrolyte between the first electrode and the second electrode; wherein power output is generated by an electrochemical reaction as the temperatures of the first electrode and the second electrode change simultaneously:

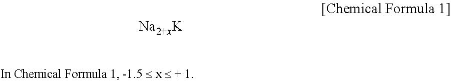

### c. Advantage of the Solution

In the novel thermal regenerative electrochemical cell of an embodiment, the Na₂₊ₓK-based alloy, which is a material exhibiting significantly high thermopower (a) in a solid-liquid phase transition region, is applied to one electrode, while applying a material that undergoes solid-liquid phase transition in a region differing from that of the Na₂₊ₓK-based alloy to the other electrode.

Accordingly, the novel thermal regenerative electrochemical cell according to an embodiment may express significantly high power and efficiency (ZT) under easy conditions of simultaneously changing a temperature of the two electrodes, compared to the conventional thermogalvanic cell.

### BRIEF DESCRIPTION OF THE DRAWINGS

FIG. 1 schematically illustrates a structure and operating principle of a conventional thermogalvanic cell.

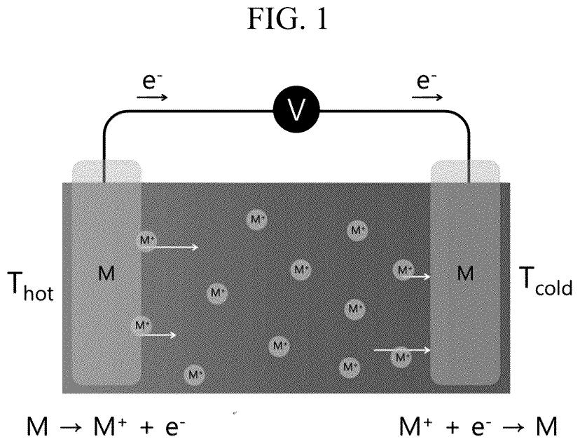

FIG. 2 schematically illustrates a structure of a novel thermally regenerative electrochemical cell according to an embodiment and an electrochemical reaction in the structure.

FIG. 3 is a graph showing a change in entropy in the region where a specific material changes phase from solid to liquid.

FIG. 4 is a graph of the solid-liquid phase transition according to the change in the K content in the alloy of Na and K.

FIG. 5 is a graph showing the thermopower (a) according to temperature change of pure Na metal, an alloy of Na and K, etc.

FIG. 6 is a graph showing the result of evaluating the thermal regenerative electrochemical cell of Example 1 with respect to an output voltage over time by changing a cell temperature from 10° C. to 4° C. (ΔT=6K) and independently, from 30° C. to 10° C. (ΔT=20K).

FIG. 7 is a graph showing the result of evaluating of the thermal regenerative electrochemical cell of Example 2 with respect to an output voltage over time by changing a cell temperature from 10° C. to 4° C. (ΔT=6K) and independently, from 30° C. 10° C. (ΔT=20K).

FIG. 8 is a graph showing the result of evaluating of the thermal regenerative electrochemical cell of Example 6 with respect to an output voltage over time by changing a cell temperature from −15° C. to −5° C. (ΔT=10K) and independently, from −5° C. to 5° C. (ΔT=10K).

### DETAILED DESCRIPTION OF THE EMBODIMENTS

Hereinafter, specific embodiments will be described in detail so that those of ordinary skill in the art can easily implement them. However, this disclosure may be embodied in many different forms and is not construed as limited to the example embodiments set forth herein.

### DEFINITION OF TERMS

The terminology used herein is used to describe embodiments only, and is not intended to limit the present invention. The singular expression includes the plural expression unless the context clearly dictates otherwise.

As used herein, “combination thereof” means a mixture, laminate, composite, copolymer, alloy, blend, reaction product, and the like of the constituents.

Here, it should be understood that terms such as “comprises,” “includes,” or “have” are intended to designate the presence of an embodied feature, number, step, element, or a combination thereof, but it does not preclude the possibility of the presence or addition of one or more other features, number, step, element, or a combination thereof.

In the drawings, the thickness of layers, films, panels, regions, etc., are exaggerated for clarity and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

“Layer” herein includes not only a shape formed on the whole surface when viewed from a plan view, but also a shape formed on a partial surface.

“Thickness” may be measured, for example, from photographs taken with an optical microscope such as a scanning electron microscope.

### (Thermally Regenerative Electrochemical Cell)

An embodiment provides a novel thermally regenerative electrochemical cell.

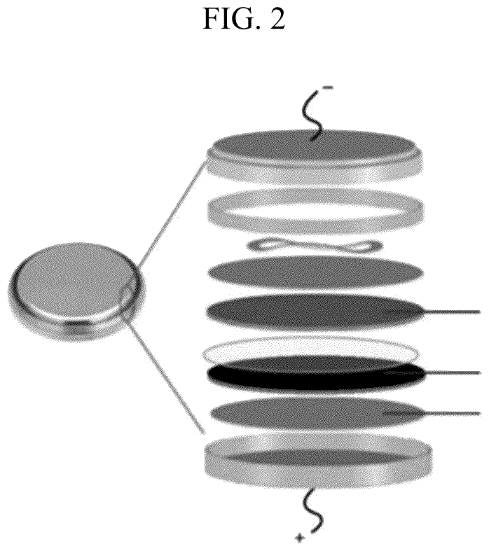

FIG. 2 schematically illustrates the structure of a novel thermally regenerative electrochemical cell according to an embodiment and the principle by which an electrochemical reaction, particularly a discharge, occurs in the structure.

The novel thermally regenerative electrochemical cell of an embodiment has a common feature with the conventional thermogalvanic cell in that it utilizes an electrochemical reaction that occurs due to a temperature difference.

However, the novel thermally regenerative electrochemical cell of an embodiment is different from the conventional thermogalvanic cell in terms of the electrode material and the structure of the element (cell) to which it is applied.

(1) A novel thermally regenerative electrochemical cell of an embodiment includes a Na₂₊ₓK-based alloy.

The Na₂₊ₓK-based alloy is an electrode material that has not been known in the field of conventional thermogalvanic cells, and is a material that can exhibit remarkably high thermopower (a) in the solid-liquid phase transition region.

(2) A novel thermally regenerative electrochemical cell of an embodiment has an asymmetric structure.

While conventional thermogalvanic cells have a symmetrical structure by applying the same material to two different electrodes, a novel thermally regenerative electrochemical cell of an embodiment includes the Na₂₊ₓK-based alloy to one electrode while applying a material different from the Na₂₊ₓK-based alloy to the other electrode.

The ‘material different from the Na₂₊ₓK-based alloy’ may be a material that undergoes a solid-liquid phase transition in a different region from the Na₂₊ₓK-based alloy.

(3) In summary, the novel thermally regenerative electrochemical cell of an embodiment includes (1) a Na₂₊ₓK-based alloy, which is a material capable of exhibiting remarkably high thermopower (a) in the solid-liquid phase transition region, (2) in an asymmetric structure.

Accordingly, under easy conditions of simultaneously changing the temperatures of the two electrodes, significantly higher power and efficiency (ZT) can be achieved compared to conventional thermogalvanic cells.

Hereinafter, a novel thermally regenerative electrochemical cell of an embodiment is described in more detail.

### Na₂₊ₓK-Based Alloy (Second Electrode Material)

In a novel thermally regenerative electrochemical cell of an embodiment, the second electrode includes an alloy represented by Chemical Formula 1:

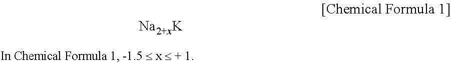

In general, in a cell that apply electrochemical reactions depending on temperature, the discharge voltage (ΔV) is determined by the chemical potential difference due to the temperature difference, while the thermal conductivity (K) and ionic conductivity (σ) are determined by the electrolyte. This can be seen from Equation 1:

$$Δ v = - \frac{1}{e} ( {μ}_{M}^{hot} - {μ}_{M}^{old} ) \qquad [ Equation 1 ]$$

In Equation 1, e is a charge amount of an electron; μ_{M}^{hot} is a chemical potential of the high-temperature electrode; and μ_{M}^{cold} is a chemical potential of the low-temperature electrode.

Meanwhile, in a cell that apply electrochemical reactions depending on temperature, the efficiency (ZT) of the cell is proportional to the thermopower (α) and ionic conductivity (σ), and inversely proportional to the thermal conductivity (κ). This can be seen from Equation 2:

$$ZT = \frac{{α}^{2} σ T}{κ} \qquad [ Equation 2 ]$$

In Equation 2, a is a thermopower of the cell; σ is an ionic conductivity of the electrolyte included in the cell; T is an operating temperature of the cell; and κ is a thermal conductivity of the electrolyte included in the cell.

According to Equation 2, in order to increase the efficiency (ZT) of a cell that applies an electrochemical reaction according to the above temperature, it is necessary to study an electrode material that exhibits high thermopower (α).

Up to now, electrode materials such as TE (Bi₂Te₃, α=0.2 mV/K), TG-Solid (LiCoO₂, α=1.2 mV/K), and TG-Liquid (Fe(CN)₆^{3-/4-}, α=4.2 mV/K) have been studied. However, for commercialization of thermogalvanic cells, electrode materials that exhibit a groundbreaking thermopower (α) exceeding 4.2 mV/K are required.

Meanwhile, the thermopower (α) of the cell applying the electrochemical reaction according to the above temperature is proportional to the change in entropy. This can be seen from Equation 3:

$$α ∝ \frac{d Δμ}{dT} = {( \frac{\partial Δ S}{\partial N} )}_{P} \qquad [ Equation 3 ]$$

In Equation 3, a is a thermopower of the cell; u is a chemical potential of the cell electrode; T is a temperature of the cell; S is the entropy of the cell electrode; and N is the number of particles in the cell electrode.

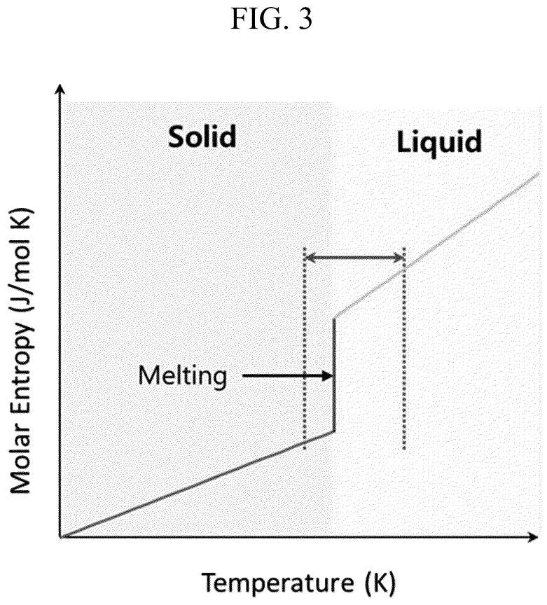

However, FIG. 3 is a graph showing the change in entropy in the region where a specific substance changes from a solid to a liquid. As shown in FIG. 3, the entropy increases rapidly in the region where the phase changes from solid to liquid (hereinafter referred to as the ‘solid-liquid phase transition’).

The alloy represented by Chemical Formula 1 can exhibit a thermopower (α) exceeding at least 4.2 mV/K and up to 26.1 mV/K in the solid-liquid phase transition region. Accordingly, the novel thermally regenerative electrochemical cell of an embodiment can exhibit high efficiency (ZT).

### Operating Principles and Temperature of Thermally Regenerative Electrochemical Cell

A novel thermally regenerative electrochemical cell of an embodiment applies a Na₂₊ₓK-based alloy, which is a material capable of exhibiting remarkably high thermopower (α) in a solid-liquid phase transition range, to one electrode, while applying a material that undergoes a solid-liquid phase transition in a different region from the Na₂₊ₓK-based alloy to the other electrode.

Here, the electrode to which a material that undergoes a solid-liquid phase transition in a different section from the Na₂₊ₓK-based alloy is applied is called the first electrode, and the electrode to which the Na₂₊ₓK-based alloy is applied is called the second electrode.

When the temperature of the electrochemical cell including the first electrode and the second electrode is increased or decreased as a whole, the temperatures of the two electrodes can change simultaneously. At this time, since the solid-liquid phase transition regions of the materials applied to the two electrodes are different, a difference in redox potential may occur between the two electrodes as the temperatures of the two electrodes change simultaneously.

Specifically, the first electrode includes Na or K, and the Na or K remains in a solid state in the solid-liquid phase transition region of the Na₂₊ₓK-based alloy.

In other words, when the temperature of the two electrodes is simultaneously increased by increasing the temperature of the electrochemical cell including the first electrode and the second electrode as a whole, the first electrode can be maintained in a solid state and only the second electrode can undergo a solid-liquid phase transition.

Due to this, an electrochemical reaction (specifically, discharge) can occur in the novel thermally regenerative electrochemical cell of an embodiment.

More specifically, the temperatures of the first electrode and the second electrode can be simultaneously changed, starting from a temperature range of less than 7° C., less than or equal to 6° C., less than or equal to 5° C., or less than or equal to 4° C. and greater than or equal to −20° C., greater than or equal to −18° C., or greater than or equal to −15° C., to a range of less than or equal to 12° C., less than or equal to 11° C., or less than or equal to 10° C. and greater than or equal to 8° C., or greater than or equal to 9° C.

For example, by simultaneously changing the temperatures of the first electrode and the second electrode from 4° C. to 8° C., a thermopower (α) of 3.4 mV/K or more can be obtained.

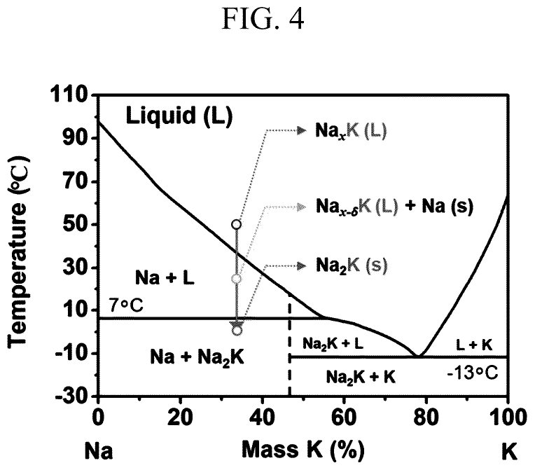

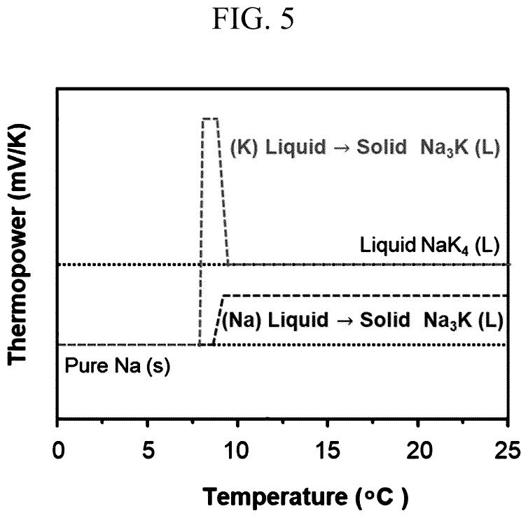

FIG. 4 is a graph of the solid-liquid phase transition according to the change in the K content in the alloy of Na and K. In addition, FIG. 5 is a graph showing the thermopower (α) according to temperature change of pure Na metal, an alloy of Na and K, etc.

In particular, since the melting point of the Na₂₊ₓK-based alloy is about 7° C., it is desirable that the first electrode be maintained in a temperature range below the melting point of the Na₂₊ₓK-based alloy (e.g., 4° C.), and the second electrode be changed from a temperature range below the melting point of the Na₂₊ₓK-based alloy to a temperature range above the melting point (e.g., from 4° C. to 8° C.).

In particular, when Na rather than K is used as the first electrode material, a higher thermopower (α) can be obtained, and the latter thermopower (α) can be greater than or equal to 5.8 mV/K. This corresponds to a case where a high thermopower (α) can be obtained compared to conventional materials such as TE (Bi₂Te₃, α=0.2 mV/K), TG-Solid (LiCoO₂, α=1.2 mV/K), and TG-Liquid (Fe(CN)₆^{3-/4-}, α=4.2 mV/K).

The fact that a higher thermopower (α) can be obtained when Na is used rather than K as the first electrode material is due to the difference in chemical potential.

### Electrolyte

In a novel thermally regenerative electrochemical cell of an embodiment, the electrolyte may include a potassium salt and a non-aqueous organic solvent.

Specifically, the potassium salt may be at least one selected from a first potassium salt including K(FSO₂)₂N(KFSI), K(CF₃SO₂)₂N(KTFSI), KPF₆, KBF₄, KClO₄, KCF₃SO₃, KC₄F₉SO₃, KAsF₆, and KN(C₂F₅SO₂)₂ (KBETI).

The non-aqueous organic solvent may be at least one selected from a glyme solvent including ethylene glycol dimethyl ether (CH₃OCH₂CH₂OCH₃: monoglyme) and diethylene glycol dimethyl ether (CH₃(OCH₂CH₂)₂OCH₃: diglyme); and a carbonate solvent including dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and butylene carbonate (BC).

The glyme solvent has higher thermal conductivity (κ) and ionic conductivity (σ) than the carbonate solvent.

Meanwhile, for the stability of the electrolyte, TTE (1,1,2,2-tetrafluoroethyl-2,2,3,3-tetrafluoropropyl ether), C₃H₂O₃ (vinylene carbonate), C₃H₃FO₃ (fluoroethylene carbonate), or a combination thereof may be added as an additive.

The additive may be included in an amount of 0.1 to 10 wt %, 1 to 8 wt %, or 3 to 7 wt %, based on 100 wt % of the total amount of the electrolyte. The stability of the electrolyte can be efficiently improved within this range.

### Structure of Thermally Regenerative Electrochemical Cell

In a novel thermally regenerative electrochemical cell of an embodiment, since the second electrode is an electrode that undergoes a phase transition from a solid to a liquid, the second electrode may be confined inside a porous substrate to suppress a change in the shape of the second electrode.

The second electrode further includes a porous substrate, and the alloy represented by Chemical Formula 1 may be impregnated inside the porous substrate.

The porous substrate may be a conductive material. Specifically, the porous substrate may be at least one selected from a metal foam including copper foam; and a porous carbon material including carbon paper, carbon cloth, and carbon felt. For example, the porous substrate may be a copper (Cu) foam.

The novel thermally regenerative electrochemical cell of an embodiment further includes a separator, and the electrolyte may be impregnated inside the separator. Since the electrolyte is a liquid, the liquid electrolyte may be confined inside a porous separator to suppress shape change of the liquid electrolyte.

The separator may be a glass filter, a porous polymer film, or an ion exchange film.

In a novel thermally regenerative electrochemical cell of an embodiment, a thickness ratio of the first electrode and the second electrode may be 1:2 to 2:1. Additionally, the thickness ratio of the first electrode and the electrolyte may be 1:1 to 250:1.

A total thickness of the thermogalvanic cell can be 0.1 to 5 cm.

Within this range, the output of the novel thermally regenerative electrochemical cell of an embodiment may be optimized.

A novel thermally regenerative electrochemical cell of an embodiment may have a coin-shaped structure.

The novel thermally regenerative electrochemical cell of an embodiment may further include a temperature control unit on each outside of the first electrode and the second electrode.

Hereinafter, examples and comparative examples of the present invention are described. The following examples are only examples of the present invention, and the present invention is not limited to the following examples.

### EXAMPLES

### Example 1: Thermal Regenerative Electrochemical Cell with Asymmetric Structure of K (First Electrode)|KPF₆ in EC₊DEC (Electrolyte)|Na₂₊ₓK (Second Electrode)

### (1) Manufacturing of First Electrode (K)

In a glove box with an environment where the concentrations of O₂ and H₂O are less than 0.1 ppm, Na and K metals are cut according to the Na—K alloy ratio, placed in a vial, and heated sufficiently to above 40° C. to form a uniform alloy. When the formed alloy is heated to a temperature of over 300° C. and an electrode such as copper foam is placed into the alloy, the alloy is impregnated into the electrode. The impregnated electrode is cooled to room temperature to manufacture the electrode.

### (2) Manufacturing of Second Electrode (Na₂₊ₓK)

The electrode is manufactured in the same manner as the first electrode.

### (3) Manufacturing of Electrolyte

An electrolyte was prepared by using 0.5 M KPF₆ as the potassium salt and EC:DEC=1:1 (v:v) as a carbonate-based solvent.

### (4) Assembly of Thermogalvanic Cell

A coin-type thermally regenerative electrochemical cell was completed by laminating the first electrode (K), the second electrode (Na₂K), and the electrolyte and elementalizing the laminate into a coin cell shape and then, disposing a temperature control unit each outside of the first electrode and the second electrode and finally, attaching a thermocouple temperature measuring apparatus thereto.

### Example 2: Thermal Regenerative Electrochemical Cell with Asymmetric Structure of Na (First Electrode)|KPF₆ in EC₊DEC (Electrolyte)|Na₂K (Second Electrode)

A thermally regenerative electrochemical cell of Example 2 was completed by changing the second electrode composition of Example 1 to Na.

### Example 3: Thermal Regenerative Electrochemical Cell with Asymmetric Structure of K (First Electrode)|KPF₆ in DMC (Electrolyte)|Na₂K (Second Electrode)

A thermally regenerative electrochemical cell of Example 3 was completed by changing the electrolyte solvent of Example 1 to DMC.

### Example 4: Thermal Regenerative Electrochemical Cell with Asymmetric Structure of K (First Electrode)|KFSI in DEGDME (Electrolyte)|Na₂K (Second Electrode)

A thermally regenerative electrochemical cell of Example 4 was completed by changing the potassium salt of Example 1 to K(FSO₂)₂N(KFSI) and also, changing the solvent to diethylene glycol dimethylether (CH₃(OCH₂CH₂)₂OCH₃: diglyme).

### Example 5: Thermal Regenerative Electrochemical Cell with Asymmetric Structure of NaK₂ (First Electrode)|KFSI in DEGDME (Electrolyte)|Na₂K (Second Electrode)

A thermally regenerative electrochemical cell of Example 5 was completed by changing the potassium salt of Example 1 to K(FSO₂)₂N(KFSI), the solvent to diethylene glycol dimethylether (CH₃(OCH₂CH₂)₂OCH₃: diglyme), and the first electrode to a NaK₂ alloy.

### Example 6: Thermal Regenerative Electrochemical Cell with Asymmetric Structure of K (First Electrode)|KFSI in DME (Electrolyte)|NaK₂ (Second Electrode)

A thermally regenerative electrochemical cell of Example 6 was completed by changing the potassium salt of Example 1 to K(FSO₂)₂N(KFSI) and also, changing the solvent to dimethylether (CH₃(OCH₂CH₂)₂OCH₃: glyme).

### Comparative Example

### Comparative Example 1: Thermal Regenerative Electrochemical Cell with Symmetrical Structure of Na₂K (First Electrode)|NaClO₄ in EC₊DEC (Electrolyte)|Na₂K (Second Electrode)

A thermally regenerative electrochemical cell of Comparative Example 1 was completed by changing the first electrode composition of Example 1 to Na₂K and also, changing the electrolyte to 1M NaClO₄ in EC:DEC=3:7 (v:v).

### Comparative Example 2: Thermal Regenerative Electrochemical Cell with Asymmetric Structure of (Fe(CN)₆³⁻ (First Electrode)|KPF₆ in EC₊DEC (Electrolyte)|Fe(CN)₆⁴⁻ (Second Electrode)

A thermally regenerative electrochemical cell of Comparative Example 2 was completed by changing the second electrode composition of Example 1 to KNiFe(CN)₆.

### Evaluation Example: Output Voltage and Thermopower According to Temperature Change of Cell

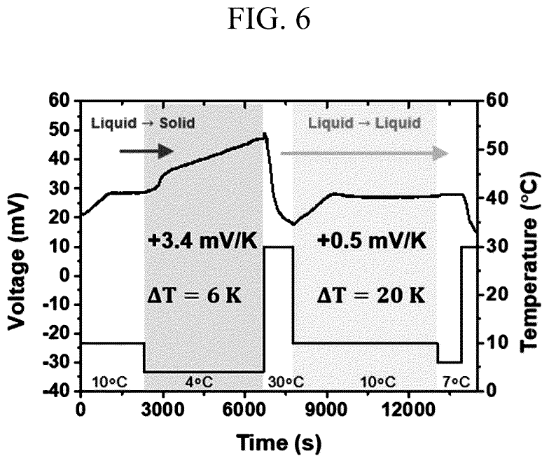

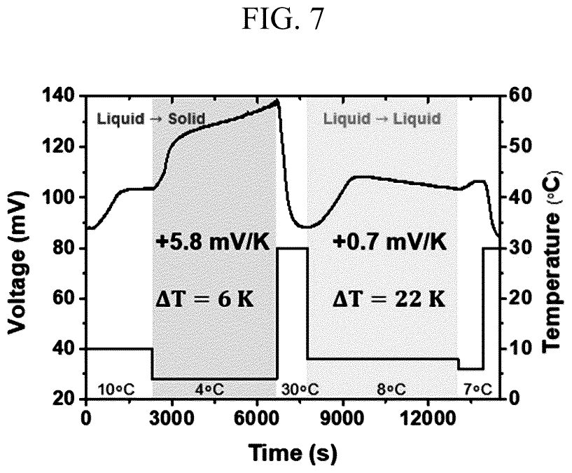

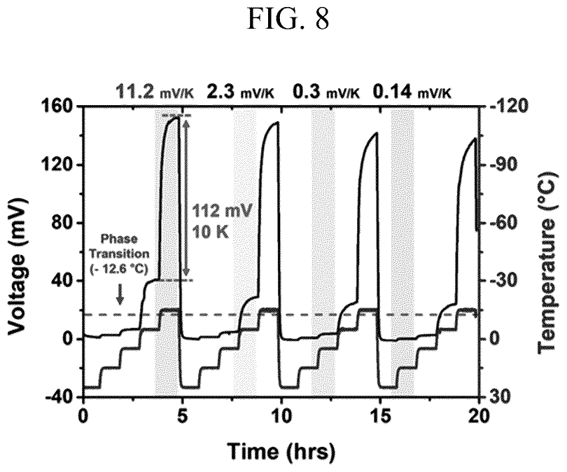

The thermally regenerative electrochemical cell of Example 1 was evaluated with respect to an output voltage over time by changing a cell temperature from a low temperature region of 10° C. to 4° C. (ΔT=6K) and independently, from a high temperature region of 30° C. to 8 and 10° C. (ΔT=22, 20K). The evaluation results are shown in FIGS. 6 and 7. In addition, the thermally regenerative electrochemical cell of Example 6 was evaluated with respect to an output voltage over time by changing a cell temperature from a low temperature region of −15° C. to −5° C. (ΔT=10K) and independently, changing from a high temperature region of −5° C. to 5° C. (ΔT=10K). The evaluation result is shown in FIG. 8.

The results of FIGS. 6, 7, and 8 are used to calculate thermopower (α) according to α=dV/dT.

Specifically, the thermally regenerative electrochemical cell of Example 1 exhibited thermopower (α) of 0.5 mV/K, when the cell temperature was changed from 30° C. to 10° C. (ΔT=20K); and thermopower (α) of 3.4 mV/K, when changed from 10° C. to 4° C. (ΔT=6K).

In addition, the thermally regenerative electrochemical cell of Example 2 exhibited thermopower (α) of 0.7 mV/K, when the cell temperature was changed from 30° C. to 8° C. (ΔT=22K); and thermopower (α) of 3.4 mV/K, when changed from 10° C. to 4° C. (ΔT=6K).

Furthermore, each of the thermally regenerative electrochemical cells of Examples 1 to 6 and Comparative Examples 1 and 2 was measured with respect to thermopower (α) according to α=dV/dT, while changing its cell temperature, and the results are shown in Table 1.

TABLE 1

| | First | | Second | | |
|---|---|---|---|---|---|
| | electrode | Electrolyte | electrode | a1 | α2 |
| Example 1 | K | KPF₆ in | Na₂K | 3.4 mV/K | 0.5 mV/K |
| | | EC + DEC | | @ 10 → 4° C. | @ 30 → 10° C.) |
| | | | | (ΔT = 6K) | (ΔT = 20K) |
| Example 2 | Na | KPF₆ in | Na₂K | 5.8 mV/K | 0.7 mV/K |
| | | EC + DEC | | @ 10 → 4° C. | @ 30 → 8° C.) |
| | | | | (ΔT = 6K) | (ΔT = 22K) |
| Example 3 | K | KPF₆ in | Na₂K | 4.78 mV/K | 0.87 mV/K |
| | | EC + DEC | | @ 10 → 4° C. | @ 30 → 10° C.) |
| | | | | (ΔT = 6K) | (ΔT = 20K) |
| Example 4 | K | KFSI in | NaK₂ | 1.7 mV/K | 0.2 mV/K |
| | | DEGDME | | @ 0 → −10° C. | @ 30 → 10° C.) |
| | | | | (ΔT = 10K) | (ΔT = 20K) |
| Example 5 | Na₂K | KFSI in | NaK₂ | 1.5 mV/K | 0.4 mV/K |
| | | DEGDME | | @ 0 → −10° C. | @ 30 → 20° C.) |
| | | | | (ΔT = 10K) | (ΔT = 10K) |
| Example 6 | K | KFSI in | NaK₂ | 11.2 mV/K | 2.3 mV/K |
| | | DEGDME | | @ −5 → −15° C. | @ 5 → −5° C.) |
| | | | | (ΔT = 10K) | (ΔT = 10K) |
| Comparative | Na₂K | NaClO₄ in | Na₂K | 0.3 mV/K | 0.1 mV/K |
| Example 1 | | EC + DEC | | @ 10 → 4° C. | @ 30 → 10° C.) |
| | | | | (ΔT = 6K) | (ΔT = 20K) |
| Comparative | K | KFSI in | KNiFe(CN)₆ | 0.2 mV/K | 0.3 mV/K |
| Example 2 | | DEGDME | | @ 10 → 4° C. | @ 30 → 10° C.) |
| | | | | (ΔT = 6K) | (ΔT = 20K) |

Referring to Table 1, Examples 1 to 6 exhibited higher thermopower (α) than Comparative Examples 1 and 2, under the same cell temperature change.

Compared with Comparative Examples 1 and 2 in which a Na or K metal was applied as a symmetrical structure, Examples 1 to 6, in which a Na₂₊ₓK-based alloy or a NaK₂ alloys (second electrode) was combined with the Na or K metal or a combination thereof (first electrode) and then, applied as an asymmetric structure, exhibited high thermopower (α). The reason is that the symmetrical electrodes had no thermopower difference between the electrodes, so that thermopower of the one was canceled by that of the other, but the asymmetric electrodes had a large thermopower difference between the electrodes.

On the other hand, in Examples 1 to 6, in which the Na₂₊ₓK-based alloy or the NaK₂ alloy (second electrode) was combined with the metals such as Na, K, or a combination thereof (first electrode) and applied as an asymmetric structure, thermopower (α) was changed according to types of the electrolytes and the cell temperature changes.

In particular, it is desirable to change the cell temperature from a temperature range below about 7° C., a melting point of the Na₂₊ₓK-based alloy, to a temperature range above the melting point (e.g., change from 4° C. to 8° C.). Or it is desirable to change the cell temperature from a temperature range of less than about −12.6° C., a melting point of the NaK₂-based alloy, to a temperature range above the melting point (e.g., change from −15° C. to −5° C.).

While this invention has been described in connection with what is presently considered to be practical example embodiments, it is to be understood that the invention is not limited to the disclosed embodiments. On the contrary, it is intended to cover various modifications and equivalent arrangements included within the spirit and scope of the appended claims.

What is claimed is:

1. A thermally regenerative electrochemical cell, comprising
a first electrode including Na, K, or a combination thereof;
a second electrode including an alloy represented by Chemical Formula 1; and
an electrolyte between the first electrode and the second electrode;
wherein power output is generated by an electrochemical reaction as the temperatures of the first electrode and the second electrode change simultaneously:

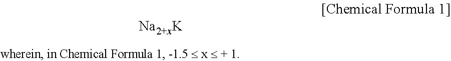

2. The thermally regenerative electrochemical cell of claim 1, wherein
the electrochemical reaction is due to the first electrode being maintained in a solid state and only the second electrode undergoing a solid-liquid phase transition.

3. The thermally regenerative electrochemical cell of claim 1, wherein
temperatures of the first electrode and the second electrode change simultaneously from a temperature range of less than 7° C. to a range of less than or equal to 12° C.

4. The thermally regenerative electrochemical cell of claim 1, wherein
the electrolyte includes a potassium salt and a non-aqueous organic solvent.

5. The thermally regenerative electrochemical cell of claim 4, wherein
the potassium salt includes at least one selected from,
a first potassium salt including K(FSO₂)₂N(KFSI), K(CF₃SO₂)₂N(KTFSI), KPF₆, KBF₄, KClO₄, KCF₃SO₃, KC₄F₉SO₃, KAsF₆, and KN(C₂F₅SO₂)₂(KBETI); and
a second potassium salt including KNO₃, and KPO₂F₂.

6. The thermally regenerative electrochemical cell of claim 4, wherein
the non-aqueous organic solvent includes at least one selected from,
a glyme-based solvent including ethylene glycol dimethylether (CH₃OCH₂CH₂OCH₃: monoglyme), and diethylene glycol dimethylether (CH₃(OCH₂CH₂)₂OCH₃: diglyme); and
a carbonate-based solvent including dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), and propylene carbonate (PC), and butylene carbonate (BC).

7. The thermally regenerative electrochemical cell of claim 4, wherein
the electrolyte further includes an additive, and
the additive includes TTE (1,1,2,2-tetrafluoroethyl-2,2,3,3-tetrafluoropropyl ether), C₃H₂O₃ (vinylene carbonate), C₃H₃FO₃ (fluoroethylene carbonate), or a combination thereof.

8. The thermally regenerative electrochemical cell of claim 7, wherein
the additive is included in an amount of 0.1 to 10 wt % based on 100 wt % of the total amount of the electrolyte.

9. The thermally regenerative electrochemical cell of claim 1, wherein
the second electrode further includes a porous substrate, and
an alloy represented by Chemical Formula 1 is impregnated into the interior of the porous substrate.

10. The thermally regenerative electrochemical cell of claim 9, wherein
the porous substrate includes at least one selected from,
a metal foam including a copper foam; and
a porous carbon material including carbon paper, carbon cloth, and carbon felt.

11. The thermally regenerative electrochemical cell of claim 1, wherein
the thermally regenerative electrochemical cell further includes a porous separator, and
the electrolyte is impregnated inside a porous separator.

12. The thermally regenerative electrochemical cell of claim 11, wherein
the separator is a glass filter, a porous polymer film, or an ion exchange film.

13. The thermally regenerative electrochemical cell of claim 1, wherein
a thickness ratio of the first electrode and the second electrode is 1:2 to 2:1.

14. The thermally regenerative electrochemical cell of claim 1, wherein
a thickness ratio of the first electrode and the electrolyte is 1:1 to 250:1.

15. The thermally regenerative electrochemical cell of claim 1, wherein
a total thickness of the thermally regenerative electrochemical cell is 0.1 to 5 cm.

16. The thermally regenerative electrochemical cell of claim 1, wherein
the thermally regenerative electrochemical cell has a coin-shaped structure.

17. The thermally regenerative electrochemical cell of claim 1, wherein
the thermally regenerative electrochemical cell further includes a temperature control unit on each outside of the first electrode and the second electrode.
